(19) United States
(12) Patent Application Publication
(10) Pub. No.: US 2012/0121962 A1
(43) Pub. Date: May 17, 2012

(54) BATTERY COOLING STRUCTURE

(75) Inventors: Goichi KATAYAMA, Wako (JP); Koichi Yamamoto, Wako (JP); Arihisa Kimura, Wako (JP)

(73) Assignee: HONDA MOTOR CO., LTD., Tokyo (JP)

(21) Appl. No.: 13/280,343

(22) Filed: Oct. 25, 2011

(30) Foreign Application Priority Data
Nov. 16, 2010 (JP) 2010-255882

(51) Int. Cl. H01M 10/50

(52) U.S. Cl. 429/120

(57) ABSTRACT

A battery cooling structure includes a first battery group, a second battery group, a third battery group, a first duct, a second duct, a third duct, a fourth duct, a fifth duct, a first connecting duct, a second connecting duct, a third connecting duct, and a bypass duct. The first duct is configured to allow a cooling medium after heat exchange to flow through the first duct. The second duct is configured to allow a cooling medium after heat exchange to flow through the second duct. The fifth duct is configured to allow a cooling medium after heat exchange to flow through the fifth duct. The bypass duct connects the fifth duct to the second duct or to the first duct.

### CROSS-REFERENCE TO RELATED APPLICATIONS

The present application claims priority under 35 U.S.C. §119 to Japanese Patent Application No. 2010-255882, filed Nov. 16, 2010, entitled “Battery Cooling Structure”. The contents of this application are incorporated herein by reference in their entirety.

### BACKGROUND OF THE INVENTION

1. Field of the Invention

The present invention relates to battery cooling structures.

2. Discussion of the Background

Japanese Unexamined Patent Application Publication No. 2010-15931 describes, as a second embodiment, a structure in which first and second exhaust ducts are disposed on both left and right sides of an intake duct (first intake duct) in the center, a first battery module is disposed between the intake duct and the first exhaust duct, and a second battery module is disposed between the intake duct and the second exhaust duct. In this structure, air supplied through the intake duct is directed to the left and right to cool the first and second battery modules. Then, the air heated by the heat exchange is discharged through the first and second exhaust ducts.

### SUMMARY OF THE INVENTION

According to one aspect of the present invention, a battery cooling structure comprises a first battery group, a second battery group, a third battery group, a first duct, a second duct, a third duct, a fourth duct, a fifth duct, a first connecting duct, a second connecting duct, a third connecting duct, and a bypass duct. The third battery group is disposed between the first battery group and the second battery group in a vehicle width direction of a vehicle. The first duct extends in a vehicle body front-rear direction of the vehicle and is configured to allow a cooling medium after heat exchange to flow through the first duct. At least part of the first duct is disposed outside the first battery group in the vehicle width direction when viewed from a vertical direction of the vehicle. The second duct extends in the vehicle body front-rear direction and is configured to allow a cooling medium after heat exchange to flow through the second duct. At least part of the second duct is disposed outside the second battery group in the vehicle width direction when viewed from the vertical direction. The third duct extends in the vehicle body front-rear direction and is configured to allow a cooling medium before heat exchange to flow through the third duct. At least part of the third duct is disposed between the first battery group and the third battery group in the vehicle width direction when viewed from the vertical direction. The fourth duct extends along the second battery group in the vehicle body front-rear direction and is configured to allow a cooling medium before heat exchange to flow through the fourth duct. At least part of the fourth duct is disposed between the second battery group and the third battery group in the vehicle width direction when viewed from the vertical direction. The fifth duct is disposed between the second battery group and the third battery group to be in contact with the fourth duct, extends along the third battery group in the vehicle body front-rear direction, and is configured to allow a cooling medium after heat exchange to flow through the fifth duct. At least part of the fifth duct is disposed between the second battery group and the third battery group in the vehicle width direction when viewed from the vertical direction. The first connecting duct connects the first duct to the third duct and extends in the vehicle width direction. The first connecting duct is configured to allow heat exchange with the first battery group. The second connecting duct connects the second duct to the fourth duct and extends in the vehicle width direction. The second connecting duct is configured to allow heat exchange with the second battery group. The third connecting duct connects the third duct to the fifth duct and extends in the vehicle width direction. The third connecting duct is configured to allow heat exchange with the third battery group. The bypass duct connects the fifth duct to the second duct or to the first duct.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a perspective view of a battery unit of an electric vehicle.

FIG. 2 illustrates the battery unit of FIG. 1, with battery modules removed.

FIG. 3 illustrates the battery unit as viewed in the direction of arrow III of FIG. 2.

FIG. 4A is a cross-sectional view taken along line IVA-IVA of FIG. 3, and FIG. 4B is a cross-sectional view taken along line IVB-IVB of FIG. 3.

FIG. 5 is a cross-sectional view taken along line V-V of FIG. 3.

FIG. 6 is an enlarged view of portion VI of FIG. 2.

FIG. 7 is a perspective view of a battery-module support stand and a power-switch support stand.

FIG. 8 is a cross-sectional view taken along line VIII-VIII of FIG. 2.

FIG. 9 is a cross-sectional view taken along line IX-IX of FIG. 3.

FIG. 10 is a cross-sectional view taken along line X-X of FIG. 3.

FIG. 11 is a function explanatory diagram corresponding to FIG. 10.

FIG. 12 is a diagram illustrating flow paths of cooling air.

FIG. 13A and FIG. 13B each illustrate a relationship between a flow direction of cooling air and a stacking direction of battery cells.

### DESCRIPTION OF THE EMBODIMENTS

The embodiments will now be described with reference to the accompanying drawings, wherein like reference numerals designate corresponding or identical elements throughout the various drawings.

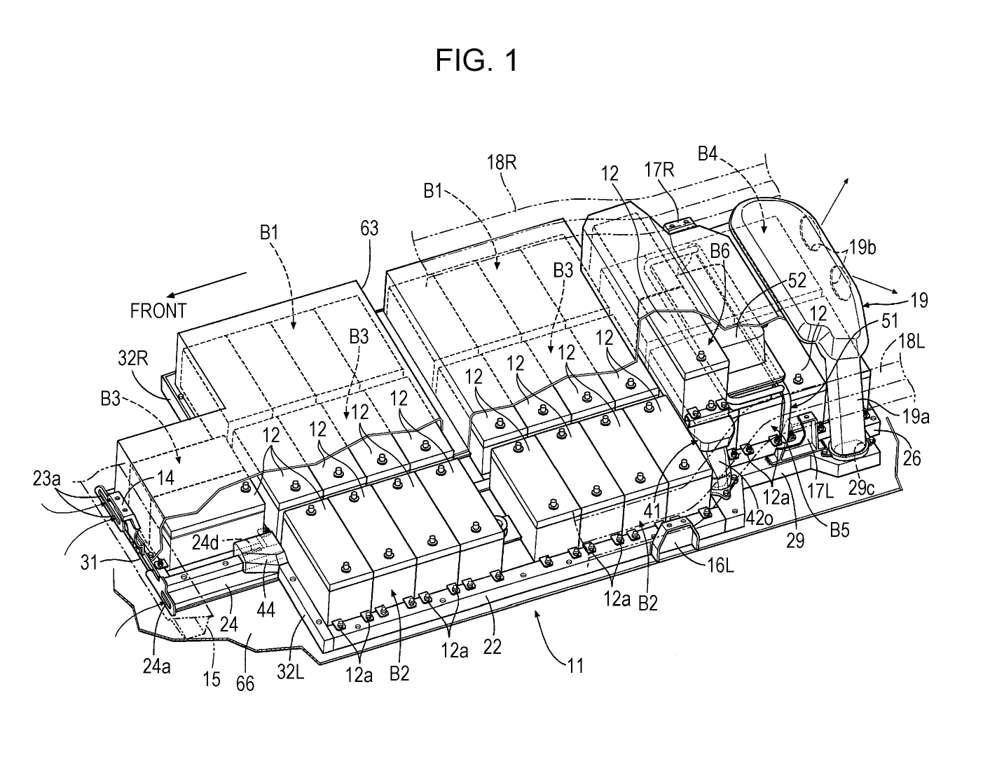

Embodiments of the present invention will now be described with reference to FIG. 1 to FIG. 13B.

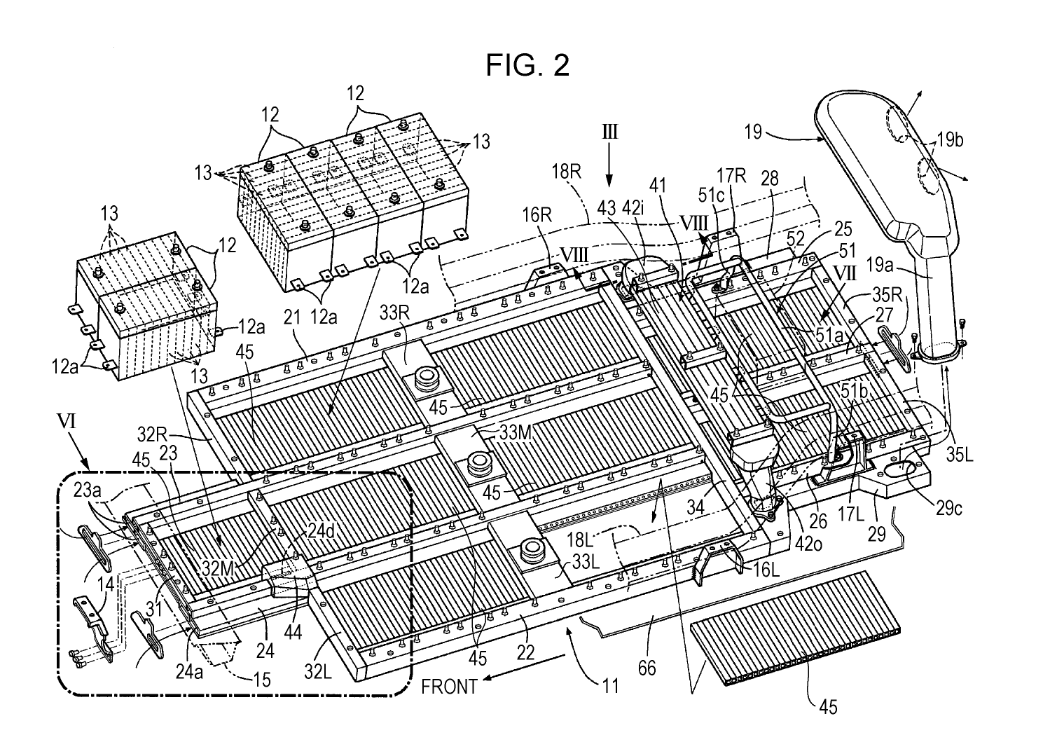

As illustrated in FIG. 1 to FIG. 3, a battery unit that supplies power to a motor-generator serving as a running power source for an electric vehicle includes a plate-like tray 11 and a plurality of battery modules 12 placed on a floor of the tray 11. Each of the battery modules 12 has a rectangular parallelepiped shape and contains a plurality of battery cells 13 (see FIG. 2) electrically connected in series. Two brackets 12a for securing each battery module 12 to the tray 11 protrude from each of both end faces of the battery module 12 in the longitudinal direction of the battery module 12.

A mounting bracket 14 at the front of the tray 11 is attached to a cross member 15 of the vehicle body, two mounting brackets 16L and 17L at the left rear of the tray 11 are attached to a side frame 18L on the left side, and two mounting brackets 16R and 17R at the right rear of the tray 11 are attached to a side frame 18R on the right side. Thus, the battery unit is supported in a suspended manner by the vehicle body. A fan unit 19 containing an electric fan (not shown) is disposed at the rear end of the tray 11. When outside air taken in by the fan unit 19 flows inside the tray 11, the battery modules 12 on the floor of the tray 11 are cooled by heat exchange between the outside air and the battery modules 12.

The tray 11 has a first longitudinal frame member 21, a second longitudinal frame member 22, a third longitudinal frame member 23, and a fourth longitudinal frame member 24 that extend in the front-rear direction of the vehicle body (vehicle body front-rear direction) such that they are parallel to one another. The first longitudinal frame member 21 is disposed on the right side in the vehicle width direction, the second longitudinal frame member 22 is disposed on the left side in the vehicle width direction, the third longitudinal frame member 23 is disposed inside the first longitudinal frame member 21 in the vehicle width direction, and the fourth longitudinal frame member 24 is disposed inside the second longitudinal frame member 22 in the vehicle width direction.

The tray 11 has a fifth longitudinal frame member 25, a sixth longitudinal frame member 26, and a seventh longitudinal frame member 27 at the rear of the first to fourth longitudinal frame members 21 to 24. The fifth to seventh longitudinal frame members 25 to 27 extend in the vehicle body front-rear direction such that they are parallel to one another. The fifth longitudinal frame member 25 is disposed on the right side in the vehicle width direction, the sixth longitudinal frame member 26 is disposed on the left side in the vehicle width direction, and the seventh longitudinal frame member 27 is disposed in the center of the vehicle body. An eighth longitudinal frame member 28 is attached parallel to the outside of the fifth longitudinal frame member 25 in the vehicle width direction, and a ninth longitudinal frame member 29 is attached parallel to the outside of the sixth longitudinal frame member 26 in the vehicle width direction.

A first transverse frame member 31 extends in the vehicle width direction to connect front ends of the third and fourth longitudinal frame members 23 and 24. Three separate second transverse frame members 32L, 32M, and 32R extend in the vehicle width direction to connect front ends of the first and second longitudinal frame members 21 and 22. The fourth longitudinal frame member 24 is interposed between the second transverse frame member 32L on the left and the second transverse frame member 32M in the middle, and the third longitudinal frame member 23 is interposed between the second transverse frame member 32M in the middle and the second transverse frame member 32R on the right. Three separate third transverse frame members 33L, 33M, and 33R extend in the vehicle width direction to connect middle parts of the first and second longitudinal frame members 21 and 22 in the front-rear direction. The fourth longitudinal frame member 24 is interposed between the third transverse frame member 33L on the left and the third transverse frame member 33M in the middle, and the third longitudinal frame member 23 is interposed between the third transverse frame member 33M in the middle and the third transverse frame member 33R on the right.

A fourth transverse frame member 34 extends in the vehicle width direction to connect rear ends of the first to fourth longitudinal frame members 21 to 24. Front ends of the fifth to seventh longitudinal frame members 25 to 27 are connected to the fourth transverse frame member 34. Two separate fifth transverse frame members 35L and 35R extend in the vehicle width direction to connect rear ends of the fifth to seventh longitudinal frame members 25 to 27.

An inlet-side leg 42i and an outlet-side leg 42o are provided to stand at front ends of the eighth longitudinal frame member 28 and the ninth longitudinal frame member 29, respectively. A rectangular plate-like heat exchange panel 43 extends in the vehicle width direction between upper ends of the inlet-side leg 42i and the outlet-side leg 42o.

The mounting bracket 14 is secured to the front surface of the first transverse frame member 31. The mounting brackets 16R and 16L are secured to the outer surfaces of the first and second longitudinal frame members 21 and 22, respectively. The mounting brackets 17R and 17L are secured to the upper surfaces of the eighth and ninth longitudinal frame members 28 and 29, respectively.

An inlet duct 19a of the fan unit 19 is secured to an opening 29c formed in the rear upper surface of the ninth longitudinal frame member 29. Two outlets 19b of the fan unit 19 are open toward the left and right rear of the vehicle body.

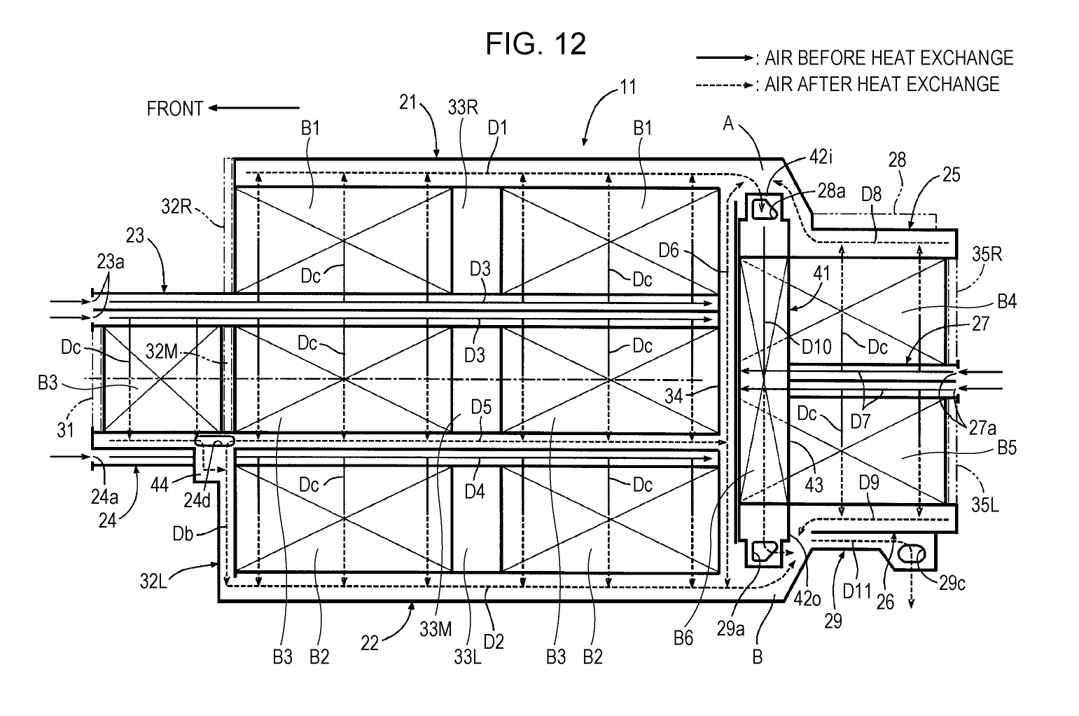

Flow paths of air that flows inside the tray 11 to serve as a cooling medium will now be described. An overall configuration of the air flow paths is schematically illustrated in FIG. 12.

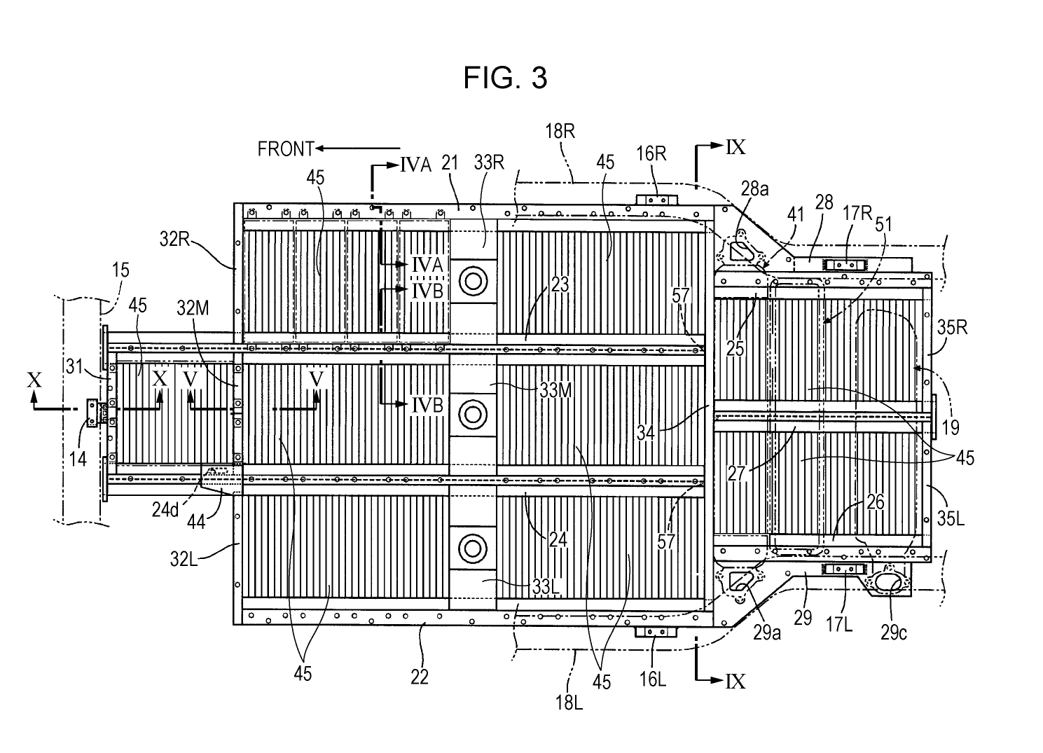

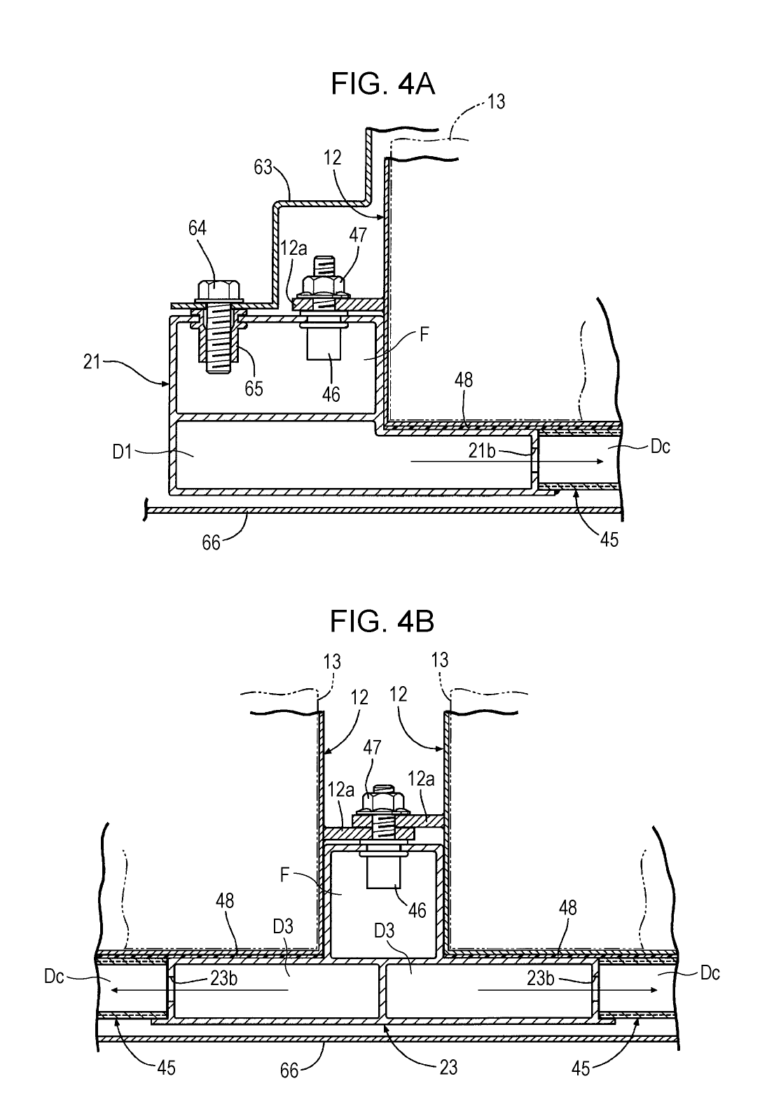

As illustrated in FIG. 3 and FIG. 12, the first longitudinal frame member 21, the second longitudinal frame member 22, the fifth longitudinal frame member 25, and the sixth longitudinal frame member 26 are extruded members identical in cross section. As illustrated in FIG. 4A, the first longitudinal frame member 21 is L-shaped in cross section. The first longitudinal frame member 21 includes a hollow frame F on the upper side and a first duct D1 on the lower side that are formed integrally. The second longitudinal frame member 22, the fifth longitudinal frame member 25, and the sixth longitudinal frame member 26, which are identical in cross section to the first longitudinal frame member 21, include a second duct D2, an eighth duct D8, and a ninth duct D9, respectively, below their respective hollow frames F. An eleventh duct D11 is formed in the interior of the ninth longitudinal frame member 29.

As illustrated in FIG. 3 and FIG. 12, the third longitudinal frame member 23, the fourth longitudinal frame member 24, and the seventh longitudinal frame member 27 are extruded members identical in cross section. As illustrated in FIG. 4B, the third longitudinal frame member 23 is inverted T-shaped in cross section. The third longitudinal frame member 23 includes a hollow frame F on the upper side and a pair of third ducts D3 on the lower side that are formed integrally. The third ducts D3 are disposed side by side in the vehicle width direction. The fourth longitudinal frame member 24 identical in cross section to the third longitudinal frame member 23 includes, below its hollow frame F, a fourth duct D4 on the left side and a fifth duct D5 on the right side in the vehicle width direction that are integral with the hollow frame F. The seventh longitudinal frame member 27 identical in cross section to the third longitudinal frame member 23 includes, below its hollow frame F, a pair of seventh ducts D7 on the left and right that are integral with the hollow frame F.

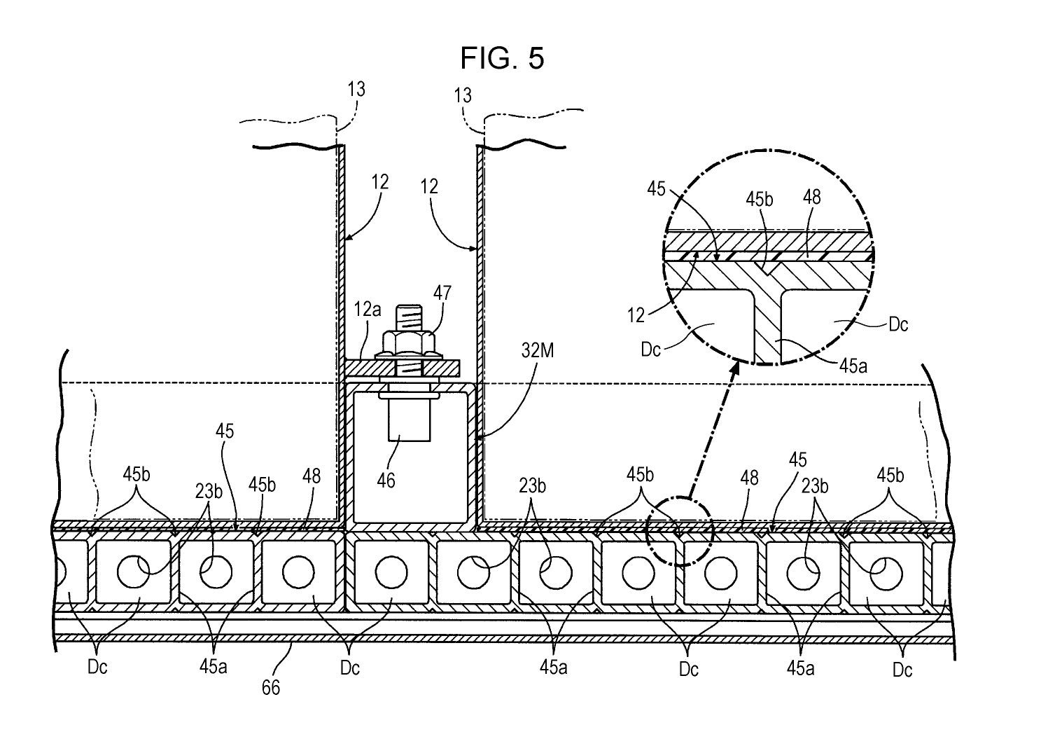

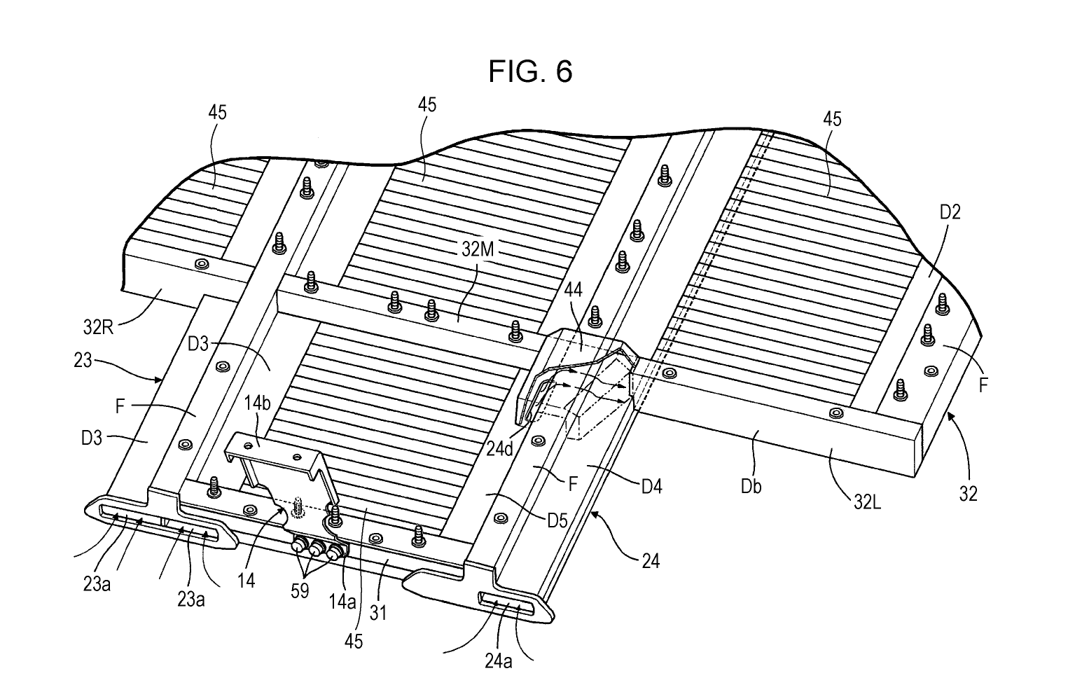

As illustrated in FIG. 3, FIG. 5, and FIG. 12, the first transverse frame member 31, the second transverse frame members 32L, 32M, and 32R, the fourth transverse frame member 34, and the fifth transverse frame members 35L and 35R are hollow extruded members rectangular in cross section. The second transverse frame member 32L on the left side forms a bypass duct Db (see FIG. 6). The bypass duct Db is connected at the left end thereof to the front end of the second duct D2. At the same time, the bypass duct Db is connected at the right end thereof, through a flow-path forming member 44 covering the upper surface of the fourth longitudinal frame member 24, to an opening 24d (see FIG. 6) in the upper surface of the fifth duct D5.

A heat insulator, such as a foam member, may be provided between the flow-path forming member 44 and the fourth duct D4. For rectification, for example, protrusions and grooves extending from the opening 24d in the upper surface toward the bypass duct Db may be added to the heat insulator. This can prevent heat exchange between low-temperature air flowing through the fourth duct D4 and high-temperature air discharged into the bypass duct Db.

The fourth transverse frame member 34 internally has a sixth duct D6, which is connected to rear ends of the first and second ducts D1 and D2, a rear end of the fifth duct D5, front ends of the eighth and ninth ducts D8 and D9, and a front end of the eleventh duct D11. Note that the second transverse frame member 32M in the middle, the second transverse frame member 32R on the right, the third transverse frame members 33L, 33M, and 33R, and the fifth transverse frame members 35L and 35R do not serve as air flow paths.

The rear end of the first duct D1, the front end of the eighth duct D8, and the right end of the sixth duct D6 collect in a first collecting area A (see FIG. 12) in front of the eighth longitudinal frame member 28. The rear end of the second duct D2, the front end of the ninth duct D9, the front end of the eleventh duct D11, and the left end of the sixth duct D6 collect in a second collecting area B (see FIG. 12) in front of the ninth longitudinal frame member 29. As illustrated in FIG. 2 and FIG. 3, the inlet-side leg 42i of a battery-module support stand 41 is connected to an opening 29a above the first collecting area A, and the outlet-side leg 42o of the battery-module support stand 41 is connected to an opening 28a above the second collecting area B. The rectangular plate-like heat exchange panel 43 extends in the vehicle width direction between the upper ends of the inlet-side leg 42i and the outlet-side leg 42o. A plurality of tenth ducts D10 are formed in the interior of the heat exchange panel 43.

Inlets 23a are formed at the front ends of the pair of third ducts D3 of the third longitudinal frame member 23. An inlet 24a is formed at the front end of the fourth duct D4 of the fourth longitudinal frame member 24. Inlets 27a are formed at the rear ends of the pair of seventh ducts D7 of the seventh longitudinal frame member 27.

The third longitudinal frame member 23 and the first longitudinal frame member 21 are connected to each other by two heat exchange panels 45, the fourth longitudinal frame member 24 and the second longitudinal frame member 22 are connected to each other by two heat exchange panels 45, the third longitudinal frame member 23 and the fourth longitudinal frame member 24 are connected to each other by three heat exchange panels 45, the seventh longitudinal frame member 27 and the fifth longitudinal frame member 25 are connected to each other by one heat exchange panel 45, and the seventh longitudinal frame member 27 and the sixth longitudinal frame member 26 are connected to each other by one heat exchange panel 45.

As illustrated in FIG. 5, many connecting ducts Dc are defined, inside each of the heat exchange panels 45, by many division walls 45a extending in the direction of air flow. Many communicating holes 21b to 27b are formed in side faces of the first to seventh longitudinal frame members 21 to 27. The internal spaces of the first to seventh longitudinal frame members 21 to 27 communicate through the communicating holes 21b to 27b with the internal spaces of the connecting ducts Dc.

As illustrated in FIG. 1 and FIG. 2, two or four battery modules 12 are supported on the upper surface of each of the heat exchange panels 45. Four brackets 12a of each battery module 12 are secured with bolts 46 and nuts 47 (see FIG. 4A and FIG. 4B) to the first to seventh longitudinal frame members 21 to 27 and the first and second transverse frame members 31 and 32M. At the same time, as illustrated in FIG. 4A, FIG. 4B, and FIG. 5, a silicone sheet 48 with high heat conductivity is sandwiched between the lower surfaces of the battery modules 12 and the upper surface of each heat exchange panel 45, and many air vent grooves 45b extending parallel to one another are formed in the upper surface of the heat exchange panel 45.

As illustrated in FIG. 1 and FIG. 12, eight battery modules 12 arranged between the first and third longitudinal frame members 21 and 23 form a first battery group B1, eight battery modules 12 arranged between the second and fourth longitudinal frame members 22 and 24 form a second battery group B2, ten battery modules 12 arranged between the third and fourth longitudinal frame members 23 and 24 form a third battery group B3, three battery modules 12 arranged between the fifth and seventh longitudinal frame members 25 and 27 form a fourth battery group B4, three battery modules 12 arranged between the sixth and seventh longitudinal frame members 26 and 27 form a fifth battery group B5, and two battery modules 12 arranged on the battery-module support stand 41 form a sixth battery group B6.

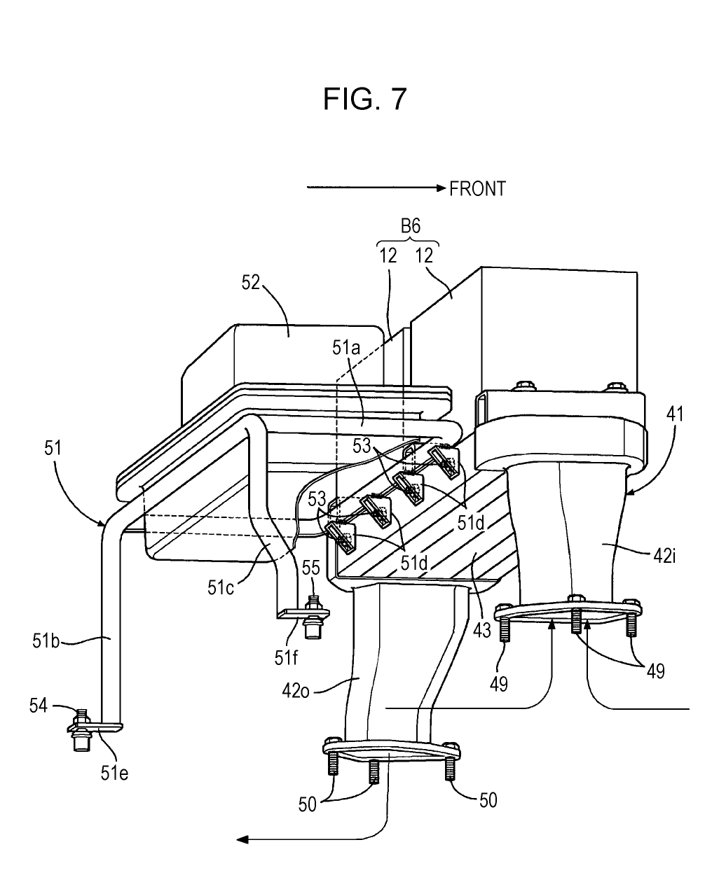

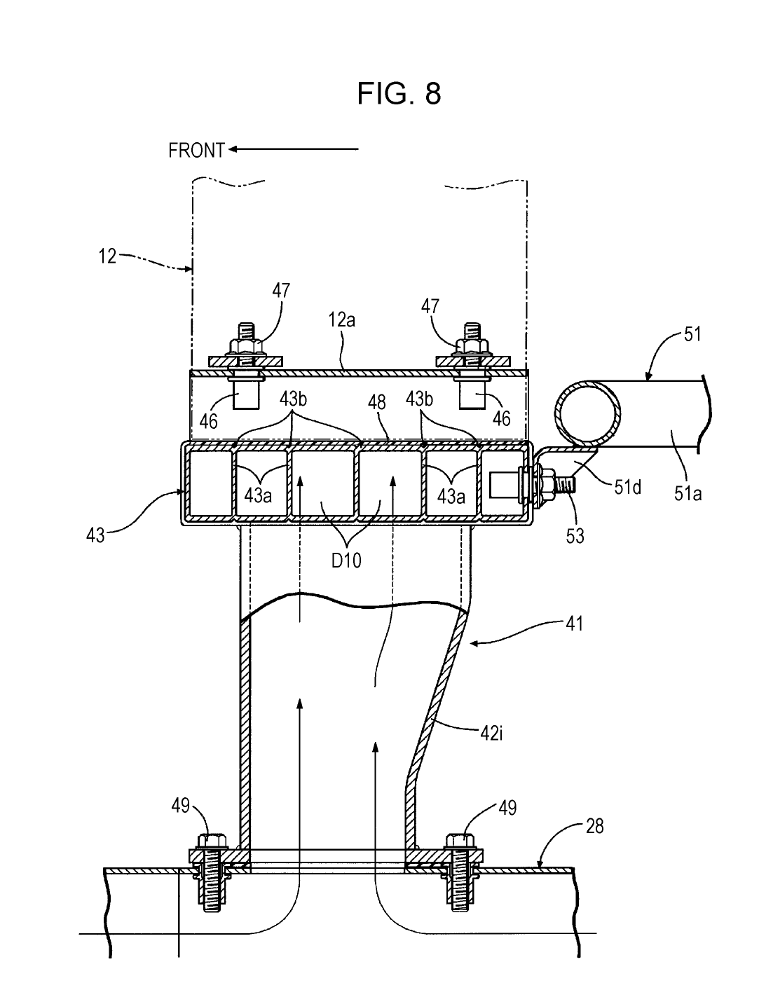

As illustrated in FIG. 2, FIG. 7, and FIG. 8, the battery-module support stand 41 includes the inlet-side leg 42i and the outlet-side leg 42o, which are hollow, and the plate-like heat exchange panel 43 that extends between the inlet-side leg 42i and the outlet-side leg 42o. The inlet-side leg 42i is secured with bolts 49 to cover the opening 28a (see FIG. 3) formed in the front upper surface of the eighth longitudinal frame member 28. The outlet-side leg 42o is secured with bolts 50 to cover the opening 29a (see FIG. 3) formed in the front upper surface of the ninth longitudinal frame member 29. The plurality of tenth ducts D10 are defined, inside the heat exchange panel 43, by a plurality of division walls 43a extending in the direction of air flow. Air vent grooves 43b are formed in the upper surface of the heat exchange panel 43. Two battery modules 12 forming the sixth battery group B6 are placed on the upper surface of the heat exchange panel 43, with the silicone sheet 48 interposed therebetween.

A power-switch support stand 51 formed of a bent metal pipe is disposed at the rear of the battery-module support stand 41. The power-switch support stand 51 includes a rectangular support frame 51a that supports a power switch 52, and a pair of left and right support legs 51b and 51c that extend downward from the left and right rear ends of the support frame 51a. A plurality of brackets 51d on the front edge of the support frame 51a are secured with bolts 53 to the rear edge of the heat exchange panel 43, a mounting bracket 51e at the lower end of the support leg 51b on the left side is secured with a bolt 54 to the upper surface of the ninth longitudinal frame member 29, and a mounting bracket 51f at the lower end of the support leg 51c on the right side is secured with a bolt 55 to the upper surface of the eighth longitudinal frame member 28. The mounting bracket 51f may be secured together with the corresponding battery module 12 by fastening the bolt 46 for retaining the battery module 12.

The mounting bracket 51e at the lower end of the support leg 51b linearly extending downward, on the left side, bends at a right angle toward the rear of the vehicle body. The mounting bracket 51f at the lower end of the support leg 51c extending downward while curving toward the front of the vehicle body, on the right side, bends at a right angle toward the front of the vehicle body.

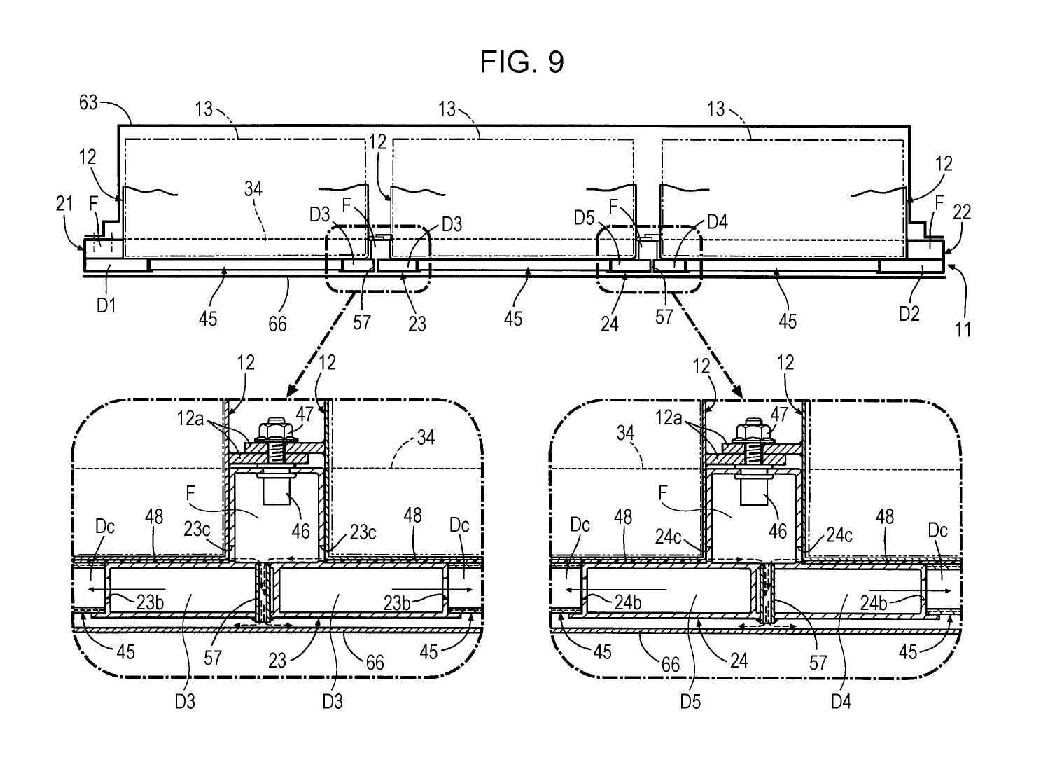

As illustrated in FIG. 9, drainage holes 23c facing the upper surfaces of the heat exchange panels 45 are formed in both left and right side faces of the hollow frame F of the third longitudinal frame member 23, and drainage holes 24c facing the upper surfaces of the heat exchange panels 45 are formed in both left and right side faces of the hollow frame F of the fourth longitudinal frame member 24. The drainage holes 23c and 24c are arranged at predetermined intervals along the length of the third and fourth longitudinal frame members 23 and 24. The drainage holes 23c and 24c allow communication between the inside and the outside of the hollow frames F of the third and fourth longitudinal frame members 23 and 24.

A drainage pipe 57 passing vertically through one of the third ducts D3 is provided at the rear end of the third longitudinal frame member 23, and a drainage pipe 57 passing vertically through the fourth duct D4 is provided at the rear end of the fourth longitudinal frame member 24. The upper ends of the drainage pipes 57 are press-fitted into the respective upper walls of the third and fourth ducts D3 and D4, and the lower ends of the drainage pipes 57 are welded to the respective lower walls of the third and fourth ducts D3 and D4. The drainage pipes 57 allow the internal spaces of the hollow frames F of the third and fourth longitudinal frame members 23 and 24 to communicate with the external space below the third and fourth ducts D3 and D4.

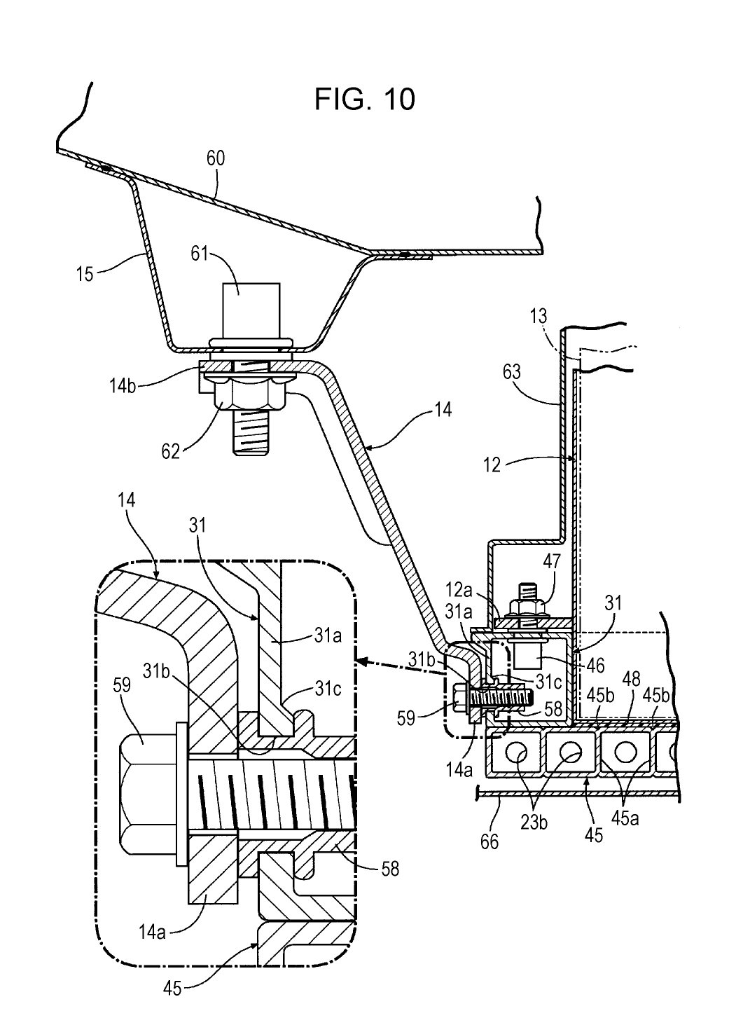

As illustrated in FIG. 6 and FIG. 10, the first transverse frame member 31 forming the front edge of the tray 11 is a hollow member which is rectangular in cross section. Three nuts 58 are secured in advance to three respective openings 31b formed in a front wall 31a of the first transverse frame member 31. A lower flange 14a at the lower end of the mounting bracket 14 extending diagonally from the upper front toward the lower rear comes into contact with the front surface of the first transverse frame member 31, and three bolts 59 that pass through the lower flange 14a are fastened to the respective nuts 58. A dashboard lower panel 60 disposed in the front part of the vehicle body extends from the upper front to the lower rear. The cross member 15 extending in the vehicle width direction is attached to the lower end of the dashboard lower panel 60. An upper flange 14b at the upper end of the mounting bracket 14 comes into contact with the lower surface of the cross member 15 and is fastened thereto with two bolts 61 and two nuts 62.

The front wall 31a of the first transverse frame member 31 has a step portion 31c that extends horizontally above the openings 31b. The front wall 31a is thicker below the step portion 31c and thinner above the step portion 31c.

As illustrated in FIG. 1, FIG. 4A, and FIG. 10, the outer edge of a battery cover 63 that covers the upper surface of the battery unit of the electric vehicle is secured with bolts 64 and nuts 65 to the outer edge of the tray 11. The lower surface of the tray 11 is covered by an undercover 66.

An operation of an embodiment of the present invention having the above-described configuration will now be described.

When the motor-generator serving as a running drive source for the vehicle is driven to perform a regenerative operation, the battery modules 12 serving as a power source for the motor-generator generate heat. It is thus necessary to ensure durability by cooling the battery modules 12 with air (outside air) that flows inside the tray 11. The battery cells 13 and the battery modules 12 are not in direct contact with outside air for cooling, and are indirectly cooled by outside air flowing through the first to seventh ducts D1 to D7. Therefore, the battery cells 13 and the battery modules 12 can be prevented from being contaminated with dust or moisture contained in the outside air.

When the fan unit 19 at the downstream end of air flow paths is driven, as illustrated in FIG. 12, air is drawn into the inlets 23a and 24a at the front ends of the third and fourth longitudinal frame members 23 and 24. The air drawn through the inlet 23a on the right side of the third longitudinal frame member 23 into the third duct D3 flows through the right side face of the third duct D3 into the connecting ducts Dc of the heat exchange panels 45 under the first battery group B1. While flowing through the connecting ducts Dc, the air cools the first battery group B1 by heat exchange. Then, the air flows into the first duct D1 of the first longitudinal frame member 21 and collects in the first collecting area A at the rear of the first duct D1.

The air drawn through the inlet 24a of the fourth longitudinal frame member 24 into the fourth duct D4 flows through the left side face of the fourth duct D4 into the connecting ducts Dc of the heat exchange panels 45 under the second battery group B2. While flowing through the connecting ducts Dc, the air cools the second battery group B2 by heat exchange. Then, the air flows into the second duct D2 of the second longitudinal frame member 22 and collects in the second collecting area B at the rear of the second duct D2.

The air drawn through the inlet 23a on the left side of the third longitudinal frame member 23 into the third duct D3 flows through the left side face of the third duct D3 into the connecting ducts Dc of the heat exchange panels 45 under the third battery group B3. While flowing through the connecting ducts Dc, the air cools the third battery group B3 by heat exchange. Then, the air flows into the fifth duct D5 of the fourth longitudinal frame member 24 and is directed to the front and rear. The air in the fifth duct D5 partially passes through the opening 24d in the upper surface of the fifth duct D5 and the interior of the flow-path forming member 44, flows into the bypass duct Db inside the second transverse frame member 32L on the left side, further flows into the front end of the second duct D2 of the second longitudinal frame member 22, and collects in the second collecting area B. The remaining air in the fifth duct D5 flows rearward into the sixth duct D6 of the fourth transverse frame member 34, and is directed to the left and right and collects in the first collecting area A and the second collecting area B.

Air drawn through the inlet 27a at the right rear end of the seventh longitudinal frame member 27 into the seventh duct D7 on the right side flows through the right side face of the seventh duct D7 into the connecting ducts Dc of the heat exchange panel 45 under the fourth battery group B4. While flowing through the connecting ducts Dc, the air cools the fourth battery group B4 by heat exchange. Then, the air flows into the eighth duct D8 of the fifth longitudinal frame member 25, flows frontward, and collects in the first collecting area A. Air drawn through the inlet 27a at the left rear end of the seventh longitudinal frame member 27 into the seventh duct D7 on the left side flows through the left side face of the seventh duct D7 into the connecting ducts Dc of the heat exchange panel 45 under the fifth battery group B5. While flowing through the connecting ducts Dc, the air cools the fifth battery group B5 by heat exchange. Then, the air flows into the ninth duct D9 of the sixth longitudinal frame member 26, flows frontward, and collects in the second collecting area B.

The air collecting in the first collecting area A passes through the opening 28a in the upper surface of the eighth longitudinal frame member 28, flows upward through the interior of the inlet-side leg 42i, and flows into the tenth ducts D10 inside the heat exchange panel 43. While flowing through the tenth ducts D10, the air cools the sixth battery group B6 by heat exchange. Then, the air flows downward through the interior of the outlet-side leg 42o, passes through the opening 29a in the upper surface of the ninth longitudinal frame member 29, and collects in the second collecting area B. The air flowing through the tenth ducts D10 inside the heat exchange panel 43 has been heated to some extent by heat exchange with the first to fifth battery groups B1 to B5. However, since all the air collecting in the first collecting area A flows through the tenth ducts D10, the performance of cooling the sixth battery group B6 can be ensured by a sufficient amount of air flow.

The silicone sheets 48 interposed between the battery modules 12 and the heat exchange panels 45 are softer than the battery modules 12 and the heat exchange panels 45. Therefore, since the silicone sheets 48 are deformed under the weight of the battery modules 12 and firmly attached to both the battery modules 12 and the heat exchange panels 45, it is possible to improve efficiency of heat exchange from the battery modules 12 to the heat exchange panels 45. At the same time, in the upper surface of each heat exchange panel 45, there are many air vent grooves 45b extending parallel to one another. The air vent grooves 45b allow air to be sandwiched between the heat exchange panel 45 and the silicone sheet 48 and can prevent the efficiency of heat exchange from being lowered.

The function effect of the silicone sheet 48 interposed between the heat exchange panel 43 of the battery-module support stand 41 and the battery modules 12, and the functional effect of the air vent grooves 43b in the upper surface of the heat exchange panel 43 are the same as those of the silicone sheets 48 and the air vent grooves 45b described above.

The air that flows inside the pair of third ducts D3 formed in contact with each other in the third longitudinal frame member 23 is low-temperature air before heat exchange. However, of the fourth duct D4 and the fifth duct D5 formed in contact with each other in the fourth longitudinal frame member 24, the fourth duct D4 allows low-temperature air before heat exchange to flow therethrough and the fifth duct D5 allows high-temperature air after heat exchange to flow therethrough. This may cause heat exchange between the air flows with different temperatures and may lower the effect of cooling the second battery group B2.

However, in the present embodiment, where the fifth duct D5 communicates through the bypass duct Db with the second duct D2, it is possible to reduce the time during which the high-temperature air after heat exchange stays inside the fifth duct D5, and thus to prevent easy occurrence of heat exchange with the low-temperature air inside the fourth duct D4. Therefore, it is possible to minimize the temperature rise of air inside the fourth duct D4 and minimize the degradation of the effect of cooling the second battery group B2.

All the battery modules 12, except two battery modules 12 of the third battery group B3 supported at the front end of the tray 11, are positioned to allow cooling air to flow in the longitudinal direction thereof, or in other words, in the direction parallel to the stacking direction of the battery cells 13 in each battery module 12.

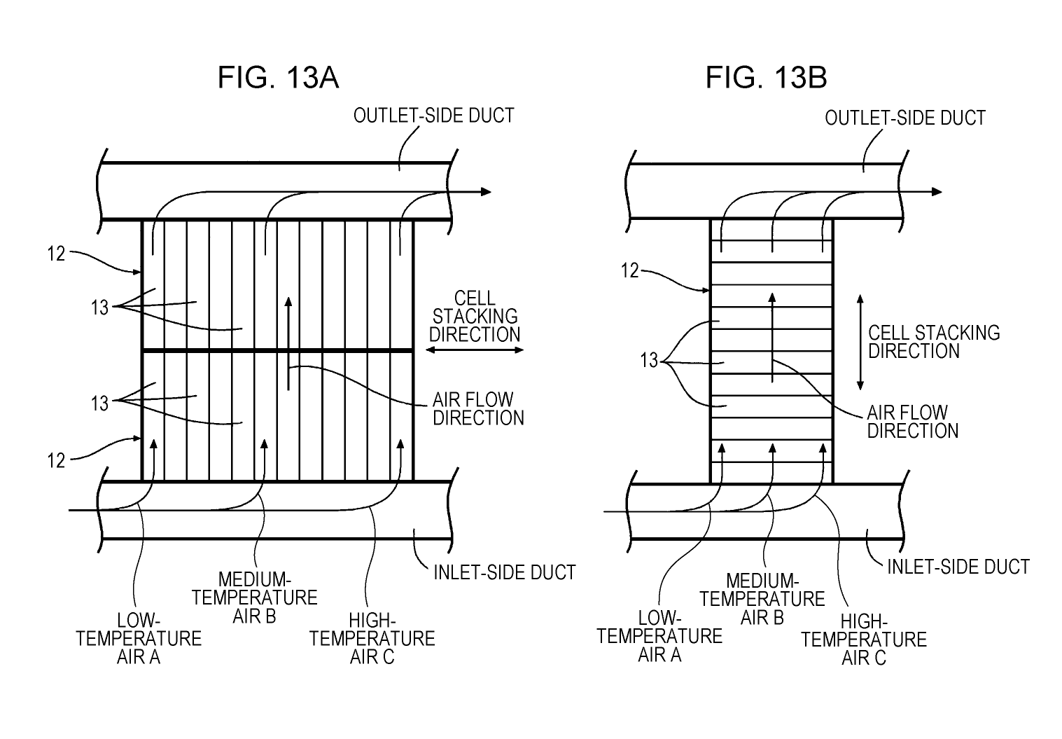

FIG. 13A illustrates a comparative example in which, unlike the above-described case, the stacking direction of the battery cells 13 in each battery module 12 is orthogonal to the direction of air flow. In this case, the temperature of air varies depending on the position at which the air flows, from the longitudinal frame member, into the heat exchange panel. Air A that changes its direction on the upstream side and flows into the heat exchange panel is low-temperature air, but air C that changes its direction on the downstream side and flows into the heat exchange panel is high-temperature air. Such differences in temperature of cooling air cause temperature variations among the battery cell 13 subjected to heat exchange with air A, the battery cell 13 subjected to heat exchange with air B, and the battery cell 13 subjected to heat exchange with air C. As a consequence, the battery cells 13 on the downstream side are not easily cooled as compared to those on the upstream side.

FIG. 13B illustrates the present embodiment in which the stacking direction of the battery cells 13 in each battery module 12 is parallel to the direction of air flow. In this case, each battery cell 13 is in contact with and is subjected to heat exchange with low-temperature air A on the upstream side, medium-temperature air B in the middle, and high-temperature air C on the downstream side. As a result, differences in temperature of air A, B, and C are evened out within each battery cell 13. Thus, since all the battery cells 13 can be uniformly cooled and temperature differences are evened out, it is possible to improve durability of the battery cells 13.

As illustrated in FIG. 7, two heavy battery modules 12 are placed on the upper surface of the heat exchange panel 43 supported by the inlet-side leg 42i and the outlet-side leg 42o of the battery-module support stand 41. An inertial force that acts on the battery modules 12 at the time of sudden starting, sudden braking, or sudden turning of the vehicle produces a moment which may cause the battery-module support stand 41 to fall. In particular, since the inlet-side leg 42i and the outlet-side leg 42o are spaced apart in the vehicle width direction and are small in width in the front-rear direction, the battery-module support stand 41 may easily fall in the front-rear direction at the time of sudden starting or sudden braking of the vehicle.

However, in the present embodiment, where the power-switch support stand 51 is attached to the rear part of the battery-module support stand 41, it is possible, with the aid of the power-switch support stand 51, to enhance stiffness of the battery-module support stand 41 against falling and improve stability of the battery-module support stand 41 at the time of sudden starting and sudden braking. As for the power-switch support stand 51, as described above, the mounting bracket 51e of the support leg 51b on the left side extends toward the rear of the vehicle body, while the support leg 51c on the right side curves toward the front of the vehicle body and the mounting bracket 51f extends toward the front of the vehicle body. This can not only enhance stiffness of the power-switch support stand 51 against falling in the front-rear direction, but can also enhance stiffness of the battery-module support stand 41 against falling in the front-rear direction. Moreover, as described above, the stiffness of the battery-module support stand 41 against falling is enhanced with the aid of the power-switch support stand 51. This can eliminate the need for special reinforcing members and reduce the number of components and cost.

The heat exchange panel 43 of the battery-module support stand 41 is disposed above the fourth and fifth battery groups B4 and B5 placed at a level lower than the sixth battery group B6. The heat exchange panel 43 has a hollow structure and supports the sixth battery group B6 on the upper surface thereof. The sixth battery group B6 at the upper level is cooled by air that flows through the tenth ducts D10 inside the heat exchange panel 43. Since the heat exchange panel 43 thus has two functions of supporting and cooling the sixth battery group B6, it is possible to reduce the number of components and simplify the structure.

Additionally, as described above, the heat exchange panel 43 is internally divided into the plurality of tenth ducts D10 by the plurality of division walls 43a extending in the direction of air flow. This can prevent the heat exchange panel 43 from collapsing under the weight of the sixth battery group B6 and can ensure the air flow paths. Moreover, the flowing resistance can be reduced by rectifying the flow of air inside the heat exchange panel 43 with the division walls 43a. Like the heat exchange panel 43 that supports the sixth battery group B6 as described above, the heat exchange panels 45 that support the first to fifth battery groups B1 to B5 can achieve the above-described function effect with the use of the division walls 45a.

If water collects on the floor of the tray 11 due to condensation or submersion in water, the battery modules 12 may get wet with the water and their durability may be lowered. However, the water collecting on the upper surfaces of the heat exchange panels 45, which form the floor of the tray 11, flows through the drainage holes 23c and 24c (see FIG. 9) of the third and fourth longitudinal frame members 23 and 24 into the interiors of the hollow frames F, passes through the drainage pipes 57 passing vertically through the third and fourth ducts D3 and D4, and is discharged to the lower surface of the tray 11. This can prevent degradation of the battery modules 12 caused by adhesion of water thereto. Additionally, with labyrinth seals formed by the drainage pipes 57, the hollow frames F, and the drainage holes 23c and 24c, it is possible to block the entry of water from the drainage pipes 57 into the tray 11. Since the third and fourth longitudinal frame members 23 and 24 are used to discharge water, it is possible to prevent an increase in the number of components and reduce complexity of the structure.

Moreover, since the third to fifth ducts D3 to D5 are formed integrally under the lower surfaces of the hollow frames F of the third and fourth longitudinal frame members 23 and 24, it is possible to reinforce the hollow frames F with the third to fifth ducts D3 to D5 and further enhance the stiffness of the tray 11. Additionally, with the drainage pipes 57 passing downward through the third and fourth ducts D3 and D4, it is possible to enhance the stiffness of the third and fourth ducts D3 and D4 against a vertical load.

Also, since the drainage pipes 57 are located at the downstream ends of the third and fourth ducts D3 and D4 in the direction of air flow, it is possible to minimize the occurrence of an event in which the flow of air inside the third and fourth ducts D3 and D4 is blocked by the drainage pipes 57. The drainage pipes 57 are provided only at the rear ends of the third and fourth ducts D3 and D4. However, since water inside the third and fourth ducts D3 and D4 flows rearward, by an inertial force, at the time of sudden starting or sudden braking, the water can be discharged smoothly.

The drainage pipes 57 are open at the lower ends thereof to face the upper surface of the undercover 66 that covers the lower surface of the tray 11. Therefore, for example, muddy water splashed by wheels as the vehicle drives can be blocked and prevented, by the undercover 66, from entering through the drainage pipes 57 into the third and fourth ducts D3 and D4.

A drainage structure provided in the third and fourth longitudinal frame members 23 and 24 has been described which prevents the first to third battery groups B1 to B3 from getting wet with water. A similar drainage structure may also be provided in the seventh longitudinal frame member 27 to prevent the fourth and fifth battery groups B4 and B5 from getting wet with water.

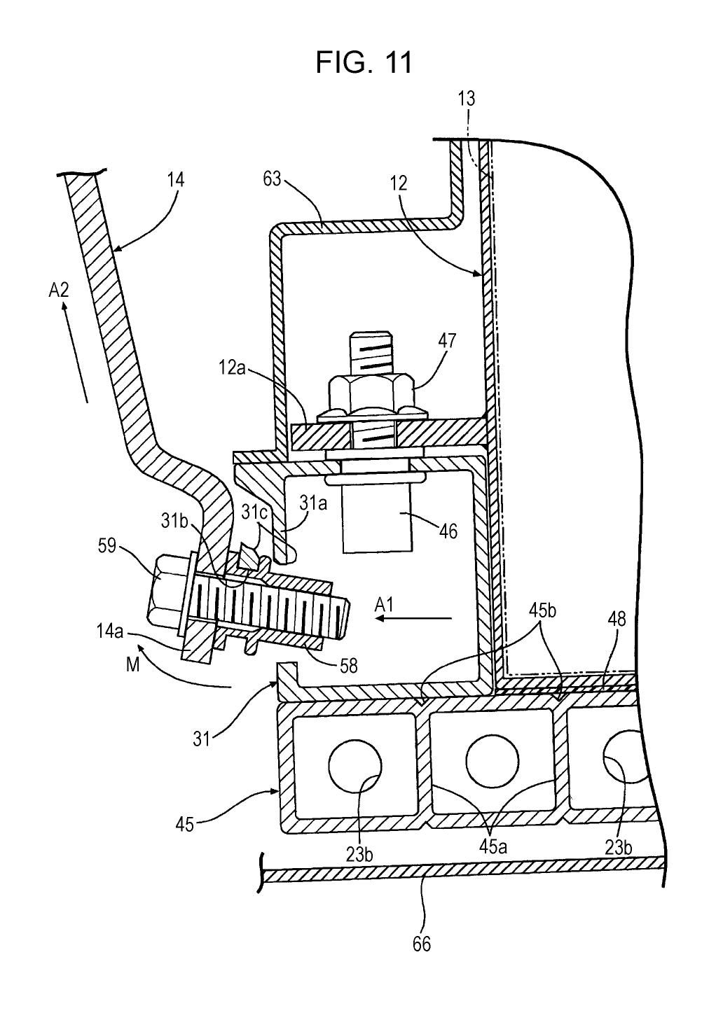

As illustrated in FIG. 11, if the vehicle collides at the front, the heavy battery unit moves frontward by an inertial force (see arrow A1). At the same time, the dashboard lower panel 60, the cross member 15, and the mounting bracket 14 are deformed upward (see arrow A2) by the collapse of the front part of the vehicle body. Therefore, a large bending moment M acts on the mounting bracket 14 secured at the upper end thereof to the cross member 15 and secured at the lower end thereof to the first transverse frame member 31 of the tray 11. The front wall 31a of the first transverse frame member 31 to which the lower flange 14a of the mounting bracket 14 is attached with the bolts 59 and the nuts 58 has the step portion 31c whose strength changes abruptly. If the step portion 31c is broken by the bending moment M, the nuts 58 are separated from the first transverse frame member 31, so that the front end of the tray 11 is separated from the mounting bracket 14.

Thus, when the front end of the tray 11 is separated from the mounting bracket 14, the deformation of vehicle body members can be isolated from the displacement of the tray 11 which is supported, at the rear part thereof, in a suspended manner by the side frames 18L and 18R with the mounting brackets 16L, 16R, 17L, and 17R. As a result, the battery unit and its surrounding high-voltage distribution system can be prevented from being deformed by stress applied thereto by deformation of the front part of the vehicle body, and can also be prevented from being pressed against vehicle body members located thereabove and causing an electrical safety failure, such as a ground fault.

Even during normal driving of the vehicle, an inertial force acts on the battery unit in the front, rear, left, and right directions, or in the up and down directions at the time of sudden starting, sudden braking, sudden turning, or when the vehicle drives on a bumpy road. Since this does not involve deformation of the dashboard lower panel 60 in the upper-rear direction (see arrow A2), the bending moment M does not occur and thus the step portion 31c is not broken.

Although embodiments of the present invention have been described, various design changes can be made within the gist of the scope of the present invention.

For example, the bypass duct Db connects the fifth duct D5 to the second duct D2 in the embodiment described above. However, the bypass duct Db may connect the fifth duct D5 to the first duct D1, or to both the second duct D2 and the first duct D1.

Although the first to sixth battery groups B1 to B6 each are an assembly of battery modules 12, they each may be an assembly of battery cells 13.

According to an embodiment of the present invention, a battery cooling structure includes a first battery group disposed on one side in a vehicle width direction; a second battery group disposed on the other side in the vehicle width direction; a third battery group disposed between the first battery group and the second battery group; a first duct disposed outside the first battery group in the vehicle width direction, extending in a vehicle body front-rear direction, and configured to allow a cooling medium after heat exchange to flow therethrough; a second duct disposed outside the second battery group in the vehicle width direction, extending in the vehicle body front-rear direction, and configured to allow a cooling medium after heat exchange to flow therethrough; a third duct disposed between the first battery group and the third battery group, extending in the vehicle body front-rear direction, and configured to allow a cooling medium before heat exchange to flow therethrough; a fourth duct disposed between the second battery group and the third battery group, extending along the second battery group in the vehicle body front-rear direction, and configured to allow a cooling medium before heat exchange to flow therethrough; a fifth duct disposed in contact with the fourth duct and between the second battery group and the third battery group, extending along the third battery group in the vehicle body front-rear direction, and configured to allow a cooling medium after heat exchange to flow therethrough; a plurality of connecting ducts configured to allow connection in the vehicle width direction between the first duct and the third duct, between the second duct and the fourth duct, and between the third duct and the fifth duct, and to allow heat exchange with the first battery group, with the second battery group, and with the third battery group; and a bypass duct configured to connect the fifth duct to the second duct or to the first duct.

In this embodiment, a part of a cooling medium supplied from the third duct, the cooling medium being a medium before heat exchange, cools the first battery group while passing through the connecting ducts and is discharged through the first duct. Another part of the cooling medium supplied from the third duct cools the third battery group while passing through the connecting ducts and is discharged, through the fifth duct and the bypass duct, to the second duct or to the first duct. A cooling medium supplied from the fourth duct, the cooling medium being a medium before heat exchange, cools the second battery group while passing through the connecting ducts and is discharged through the second duct.

The fourth duct which allows a cooling medium before heat exchange to flow therethrough and the fifth duct which allows a cooling medium after heat exchange to flow therethrough are in contact with each other. Since the cooling medium before heat exchange in the fourth duct is warmed by the cooling medium after heat exchange in the fifth duct, the effect of cooling the second battery group may be lowered. However, by allowing the cooling medium after heat exchange in the fifth duct to be partially discharged through the bypass duct to the second duct or to the first duct, it is possible to reduce the time during which the cooling medium after heat exchange stays in the fifth duct, prevent the cooling medium before heat exchange in the fourth duct from being easily warmed up, and ensure the effect of cooling the second battery group. It is thus possible to even out the temperatures of the first to third battery groups and improve the durability of the first to third battery groups.

According to an embodiment of the present invention, in addition to the configuration of the first aspect, a heat transfer member may be disposed between upper surfaces of the connecting ducts and a lower surface of each of the first to third battery groups. The heat transfer member may be softer than the upper surfaces of the connecting ducts and the lower surface of each of the first to third battery groups.

In this embodiment, the heat transfer member is deformed and firmly attached to the upper surfaces of the connecting ducts and the lower surface of each of the first to third battery groups. It is thus possible to ensure a large heat transfer area and enhance the effect of cooling the first to third battery groups.

According to an embodiment of the present invention, in addition to the configuration of the second aspect, a plurality of air vent grooves for discharging air between the heat transfer member and the upper surfaces of the connecting ducts may be formed in the upper surfaces of the connecting ducts.

In this embodiment, air between the upper surfaces of the connecting ducts and the lower surface of the heat transfer member is discharged through the air vent grooves. Therefore, it is possible to further enhance the effect of cooling the first to third battery groups.

According to an embodiment of the present invention, in addition to the configuration of the first aspect, the first to third battery groups each may be formed by stacking a plurality of battery cells, and the stacking direction may be parallel to a direction in which a cooling medium flows through the connecting ducts.

In this embodiment, even if the timing at which a cooling medium before heat exchange flows from the third and fourth ducts into the connecting ducts varies depending on the location in the vehicle body front-rear direction, the timing variations can be evened out in each battery cell. It is thus possible to prevent occurrence of temperature differences among battery cells.

Note that a silicone sheet 48 corresponds to a heat transfer member.

Obviously, numerous modifications and variations of the present invention are possible in light of the above teachings. It is therefore to be understood that within the scope of the appended claims, the invention may be practiced otherwise than as specifically described herein.

What is claimed is:

1. A battery cooling structure comprising:
a first battery group;
a second battery group;
a third battery group disposed between the first battery group and the second battery group in a vehicle width direction of a vehicle;
a first duct extending in a vehicle body front-rear direction of the vehicle and configured to allow a cooling medium after heat exchange to flow through the first duct, at least part of the first duct being disposed outside the first battery group in the vehicle width direction when viewed from a vertical direction of the vehicle;
a second duct extending in the vehicle body front-rear direction and configured to allow a cooling medium after heat exchange to flow through the second duct, at least part of the second duct being disposed outside the second battery group in the vehicle width direction when viewed from the vertical direction;
a third duct extending in the vehicle body front-rear direction and configured to allow a cooling medium before heat exchange to flow through the third duct, at least part of the third duct being disposed between the first battery group and the third battery group in the vehicle width direction when viewed from the vertical direction;
a fourth duct extending along the second battery group in the vehicle body front-rear direction and configured to allow a cooling medium before heat exchange to flow through the fourth duct, at least part of the fourth duct being disposed between the second battery group and the third battery group in the vehicle width direction when viewed from the vertical direction;
a fifth duct disposed between the second battery group and the third battery group to be in contact with the fourth duct, extending along the third battery group in the vehicle body front-rear direction, and configured to allow a cooling medium after heat exchange to flow through the fifth duct, at least part of the fifth duct being disposed between the second battery group and the third battery group in the vehicle width direction when viewed from the vertical direction;
a first connecting duct connecting the first duct to the third duct and extending in the vehicle width direction, the first connecting duct being configured to allow heat exchange with the first battery group;
a second connecting duct connecting the second duct to the fourth duct and extending in the vehicle width direction, the second connecting duct being configured to allow heat exchange with the second battery group;
a third connecting duct connecting the third duct to the fifth duct and extending in the vehicle width direction, the third connecting duct being configured to allow heat exchange with the third battery group; and
a bypass duct connecting the fifth duct to the second duct or to the first duct.

2. The battery cooling structure according to claim 1, further comprising:
a heat transfer member disposed between an upper surface of each of the first to third connecting ducts and a lower surface of each of the first to third battery groups, the heat transfer member being softer than the upper surface of each of the first to third connecting ducts and the lower surface of each of the first to third battery groups.

3. The battery cooling structure according to claim 2, further comprising:
a plurality of air vent grooves disposed in the upper surface of each of the first to third connecting ducts, each of the air vent grooves being configured to discharge air between the heat transfer member and the upper surface of each of the first to third connecting ducts.

4. The battery cooling structure according to claim 1, wherein
each of the first to third battery groups is provided by stacking a plurality of battery cells in a stacking direction, and
the stacking direction is substantially parallel to a direction in which a cooling medium flows through the first to third connecting ducts.

5. The battery cooling structure according to claim 1, wherein
the bypass duct connects the fifth duct to the second duct, and
at least part of the bypass duct is disposed outside the second battery group in the vehicle body front-rear direction when viewed from the vertical direction.

6. The battery cooling structure according to claim 5, wherein
a part of the bypass duct is disposed on an upper side of the fourth duct.

7. The battery cooling structure according to claim 5, further comprising:
a battery frame member disposed between the second and third battery groups in the vehicle width direction and extending in the vehicle body front-rear direction, wherein
the second and third battery groups are attached to the battery frame member,
at least part of the fourth duct is disposed under the fourth frame member, and
a part of the bypass duct is disposed on an upper side of the battery frame member.
